(19) United States
(12) Patent Application Publication
(10) Pub. No.: US 2011/0043745 A1
(43) Pub. Date: Feb. 24, 2011

(54) DISPLAY APPARATUS AND METHOD OF MANUFACTURING THE SAME

(76) Inventors: HEE-KEUN LEE, Suwon-si (KR); Nakcho Choi, Seoul (KR); Taesung Jung, Yongin-si (KR); Haeju Yun, Nam-gu (KR)

Correspondence Address: F. CHAU & ASSOCIATES, LLC, 130 WOODBURY ROAD, WOODBURY, NY, 11797, US

(21) Appl. No.: 12/691,883

(22) Filed: Jan. 22, 2010

(30) Foreign Application Priority Data
Aug. 19, 2009 (KR) 10-2009-0076853

(51) Int. Cl. G02F 1/1333; G02F 1/13

(52) U.S. Cl. 349/160; 349/187

(57) ABSTRACT

A display apparatus includes a first base substrate having pixel areas, a second base substrate facing the first base substrate, and barriers dividing the pixel areas into a plurality of pixel area groups. Each barrier includes at least two sub-barriers spaced apart from each other, and a coupling member is arranged between and on each of the at least two sub-barriers to couple the barrier with the first or second base substrates.

### CROSS-REFERENCE TO RELATED APPLICATION

This application relies for priority upon Korean Patent Application No. 10-2009-0076853 filed on Aug. 19, 2009, the contents of which are herein incorporated by reference in its entirety.

### BACKGROUND

1. Technical Field

The present invention relates to a display apparatus and, more particularly, to a display apparatus having improved display quality and a method of manufacturing the display apparatus.

2. Discussion of the Related Art

A display apparatus displaying an image may be classified into a liquid crystal display (LCD), an organic light emitting display, an electrophoresis display device, and a plasma display device according to its operation principles. The LCD, in general, includes two substrates facing each other, electrodes arranged on the two substrates, and liquid crystal disposed between the two substrates.

In addition, an operation of the LCD differs according to what kinds of liquid crystal are used in the LCD. For example, in the case of the LCD employing a cholesteric liquid crystal, the cholesteric liquid crystal reflects incident external light, and a wavelength of the reflected light is determined by controlling the amount of dopant in the cholesteric liquid crystal. The LCD displays the image using the above-mentioned properties of the cholesteric liquid crystal.

### SUMMARY

Embodiments provide a display apparatus having an improved display quality and a method of manufacturing the display apparatus.

According to an embodiment, a display apparatus includes a first base substrate including pixel areas, a second base substrate facing the first base substrate, pixel electrodes arranged on the first base substrate respectively corresponding to the pixel areas, a common electrode arranged on the second base substrate to form an electric field with the pixel electrodes, barriers each having at least two sub-barriers spaced apart from each other and being arranged on the first base substrate or on the second base substrate, a coupling member arranged between and on each of the at least two sub-barriers to couple the first base substrate on which the pixel electrodes are arranged with the second base substrate on which the common electrode is arranged, and a liquid crystal layer disposed between the first base substrate and the second base substrate.

According to an embodiment, a display apparatus includes a first base substrate including pixel areas, a second base substrate facing the first base substrate, pixel electrodes arranged on the first base substrate respectively corresponding to the pixel areas, a common electrode arranged on the second base substrate to form an electric field with the pixel electrodes, barriers arranged on the first base substrate or on the second base substrate, a coupling member arranged on each of the barriers to couple the first base substrate on which the pixel electrodes are arranged with the second base substrate on which the common electrode is arranged, and a liquid crystal layer filling spaces that are defined by the barriers and the coupling members between the first base substrate and the second base substrate.

Each of the barriers may have a rounded shape that makes contact with the coupling member.

According to an embodiment, a display apparatus includes a first base substrate including pixel areas, a second base substrate facing the first base substrate, pixel electrodes arranged on the first base substrate respectively corresponding to the pixel areas, a common electrode arranged on the second base substrate to form an electric field with the pixel electrodes, barriers arranged on the first base substrate or on the second base substrate, a coupling member arranged on each of the barriers to couple the first base substrate on which the pixel electrodes are arranged with the second base substrate on which the common electrode is arranged, and a liquid crystal layer filling spaces that are defined by the barriers and the coupling members between the first base substrate and the second base substrate.

Each of the barriers may have at least one side surface that is inclined with respect to the first and second base substrates in a cross-sectional view, and the coupling member extends from an upper portion of each of the barriers to the side surface of each of the barriers.

According to an embodiment, a method of manufacturing the liquid crystal display is provided as follows. Pixel electrodes are formed on a first base substrate having pixel areas to respectively correspond to the pixel areas, a common electrode is formed on a second base substrate. Barriers each having at least two sub-barriers spaced apart from each other are formed on the first base substrate or the second base substrate, wherein the barriers divide the pixel areas into a plurality of pixel area groups.

Then, the first base substrate is coupled with the second base substrate, wherein the barriers are positioned between the first base substrate and the second base substrate. A coupling member is formed between and on each of the at least two sub-barriers to couple the barriers with the first and second base substrates, and a liquid crystal layer is formed between the first base substrate and the second base substrate.

According to the above, the barriers positioned between two substrates facing each other are firmly coupled with the two substrates by the coupling member. Thus, liquid crystal layers doped with different dopant may be prevented from being mixed with each other by the barriers and the coupling member, thereby preventing deterioration of a display quality of the display apparatus.

### BRIEF DESCRIPTION OF THE DRAWINGS

Example embodiments of the present invention will become readily apparent by reference to the following detailed description when considered in conjunction with the accompanying drawings wherein:

FIG. 1 is a perspective view showing a display apparatus according to an exemplary embodiment of the present invention;

FIG. 2A is a partially enlarged plan view showing a display apparatus of FIG. 1;

FIG. 2B is a cross-sectional view taken along a line I-I′ of FIG. 2;

FIG. 3 is a cross-sectional view showing a display apparatus according to an exemplary embodiment of the present invention;

FIG. 4 is a cross-sectional view showing a display apparatus according to an exemplary embodiment of the present invention;

FIG. 5 is a cross-sectional view showing a display apparatus according to an exemplary embodiment of the present invention; and

FIGS. 6 to 10 are views illustrating a method of manufacturing a display apparatus of FIG. 1, according to an exemplary embodiment of the present invention.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers may refer to like elements throughout.

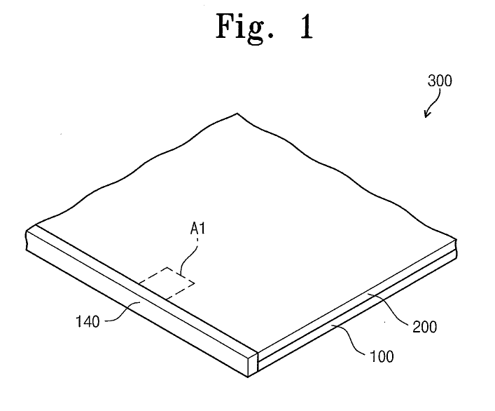

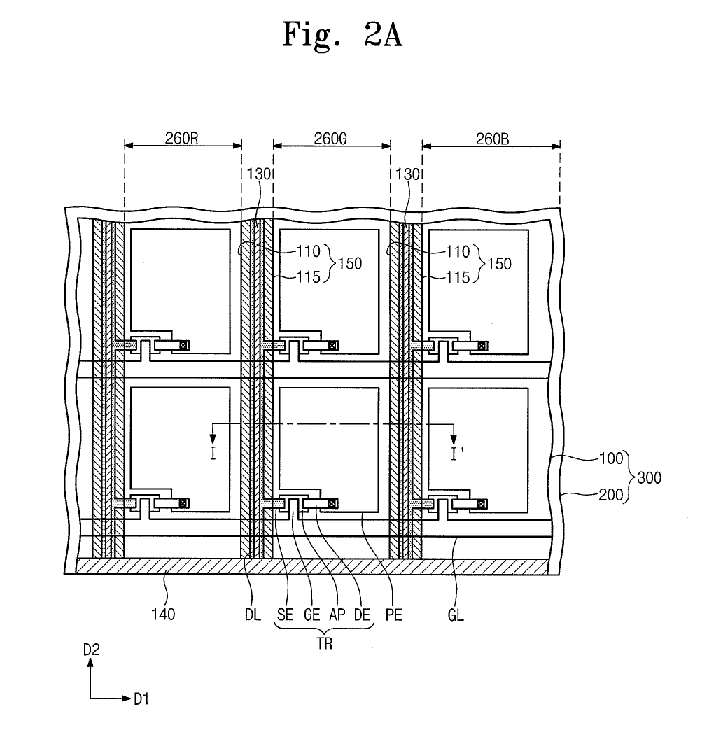

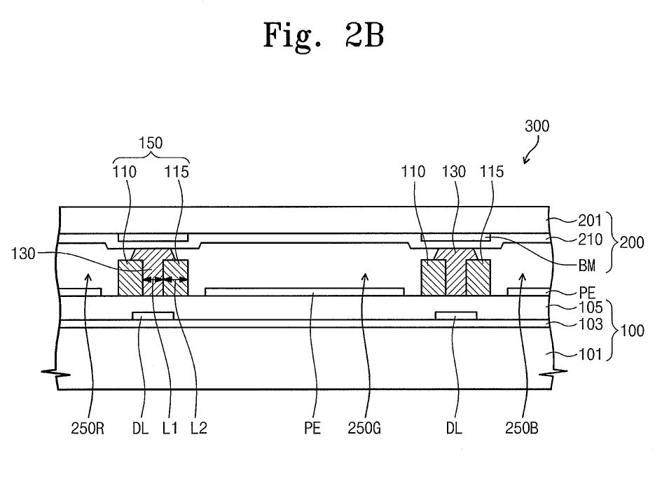

FIG. 1 is a perspective view showing a display apparatus according to an exemplary embodiment of the present invention, FIG. 2A is a partially enlarged plan view showing the display apparatus of FIG. 1, and FIG. 2B is a cross-sectional view taken along a line I-I′ of FIG. 2.

Referring to FIGS. 1, 2A, and 2B, a display apparatus 300 includes a first substrate 100 and a second substrate 200 facing the first substrate 100.

The first substrate 100 includes a first base substrate 101 having pixel areas, gate lines GL arranged on the first base substrate 101, data lines DL arranged on the first base substrate 101 and insulated from the gate line GL, thin film transistors TR arranged on the first base substrate 101, and pixel electrodes PE arranged in the pixel areas. According to an exemplary embodiment, the pixel areas have the same structure, and the structure of one pixel area will be described as a representative example.

The first base substrate 101 is a thin transparent substrate and includes the pixel areas. Although not shown in FIG. 2A, according to an embodiment, an area where each pixel area is defined is substantially the same as an area where a pixel electrode PE is defined.

The thin film transistor TR includes a gate electrode GE branched from the gate line GL, an active pattern AP arranged on the gate electrode GE, wherein a gate insulating layer 103 is interposed between the active pattern AP and the gate electrode GE, a source electrode SE branched from the data line DL and arranged on the active pattern AP, and a drain electrode DE spaced apart from the source electrode SE and electrically connected to the pixel electrode PE. In addition, an inter-insulating layer 105 is arranged on the first base substrate 101 to cover the data line DL, the source electrode SE, and the drain electrode DE. The pixel electrode PE electrically connected to the drain electrode DE is arranged on the inter-insulating layer 105. The thin film transistor TR is turned on in response to a gate signal provided through the gate line GL. As a result, a data signal provided through the data line DL is applied to the pixel electrode PE when the thin film transistor TR is turned on.

The second substrate 200 includes a second base substrate 201, a black matrix BM arranged on the second base substrate 201 and overlapping the data line DL in a plan view, and a common electrode 210 arranged on the second base substrate 201 and covering the black matrix BM.

The common electrode 210 forms an electric field with the pixel electrode PE to control directors of liquid crystal molecules included in a first liquid crystal layer 250R, a second liquid crystal layer 250G, and a third liquid crystal layer 250B, which are arranged between the first substrate 100 and the second substrate 200.

A barrier 150 is arranged between the first substrate 100 and the second substrate 200. When viewed in a plan view, the barrier 150 overlaps with the data line DL, and the barrier 150 divides the pixel areas into a plurality of pixel area groups. More particularly, the barrier 150 divides the pixel areas into a first pixel area group 260R, a second pixel area group 260G, and a third pixel area group 260B.

The first pixel area group 260R includes pixel areas arranged in a second direction D2 among the pixel areas. Similarly, each of the second pixel area group 260G and the third pixel area group 260B includes pixel areas arranged in the second direction D2 among the pixel areas. Thus, in a plan view, the barrier 150 is positioned between two adjacent pixel area groups to separate the two pixel area groups from each other.

Also, since the barrier 150 is positioned between the first and second substrates 100 and 200, spaces in which the first to third liquid crystal layers 250R, 250G, and 250B are filled are defined between the first and second substrates 100 and 200 by the barrier 150. The first to third liquid crystal layers respectively correspond to the first to third pixel groups 260R, 260G and 260B.

According to an exemplary embodiment, the barrier 150 includes a first sub-barrier 110 and a second sub-barrier 115. The first and second sub-barriers 110 and 115 extend in the second direction D2 and are spaced apart from each other.

According to an exemplary embodiment, a first length L1 that indicates a distance between the first and second sub-barriers 110 and 115 may have a maximum value of about 50 micrometers. A second length L2 that indicates a width of each of the first and second sub-barriers 110 and 115 may be within a range from about 5 micrometers to about 30 micrometers.

A coupling member 130 is arranged between the first sub-barrier 110 and the second sub-barrier 115 and on the first sub-barrier 110 and the second sub-barrier 115. The coupling member 130 couples the first and second sub-barriers 110 and 115 with the second substrate 200 to prevent two or three of the first to third liquid crystal layers 250R, 250G, and 250B from being mixed with each other.

As described above, the barrier 150 defines the spaces between the first and second substrates 100, 200 in which the first to third liquid crystal layers 250R, 250G, and 250B are filled. The first to third liquid crystal layers 250R, 250G and 250B correspond to the first to third pixel area groups 260R, 260G, and 260B, respectively. That is, the barrier 150 separates the spaces from each other, in which the first to third liquid crystal layers 250R, 250G, and 250B are filled. However, if the barrier 150 does not make contact with the second substrate 200, for example, if the coupling member 130 is removed, two or three of the first to third liquid crystal layers 250R, 250G, and 250B may be mixed with each other. However, according to an exemplary embodiment, the coupling member 130 is arranged on the barrier 150 to tightly couple the barrier 150 with the second substrate 200. Consequently, the coupling member 130 and the barrier 150 completely separate the spaces, in which the first to third liquid crystal layers 250R, 250G, and 250B are filled, from each other to prevent two or three of the first to third liquid crystal layers 250R, 250G, and 250B from being mixed with each other.

According to an exemplary embodiment, mixing of the first to third liquid crystal layers 250R, 250G, and 250B with each other is prevented. The reason to prevent mixing is because the first to third liquid crystal layers 250R, 250G, and 250B include the cholesteric liquid crystal, and at least one liquid crystal layer of the first to third liquid crystal layers 250R, 250G, and 250B may include a different amount of chiral dopant from the other two liquid crystal layers.

In general, the cholesteric liquid crystal may change a wavelength of light that is provided thereto from an exterior and reflected thereby by controlling the amount of the chiral dopant doped in the cholesteric liquid crystal. More particularly, as the amount of the chiral dopant doped in the cholesteric liquid crystal increases, the wavelength of the light reflected by the cholesteric liquid crystal is reduced.

Thus, in the first to third liquid crystal layers 250R, 250G, and 250B doped with the cholesteric liquid crystal, assuming that an amount of the chiral dopant doped in the first liquid crystal layer 250R is referred to as a first amount, an amount of the chiral dopant doped in the second liquid crystal layer 250G is referred to as a second amount, and an amount of the chiral dopant doped in the third liquid crystal layer 250B is referred to as a third amount, the third amount is larger than the second amount, and the second amount is larger than the first amount. As a result, light reflected by the third liquid crystal layer 250B may have the shortest wavelength, and light reflected by the first liquid crystal layer 250R may have the longest wavelength.

As described above, since the first liquid crystal layer 250R, the second liquid crystal layer 250G, and the third liquid crystal layer 250B have different optical characteristics from each other, the first to third liquid crystal layers 250R, 250G, and 250B are prevented from being mixed with each other by the barrier 150 and the coupling member 130.

As shown in FIGS. 1 and 2A, a sealant 140 is arranged on at least one side surface of the display apparatus 300 to seal the first to third liquid crystal layers 250R, 250G, and 250B.

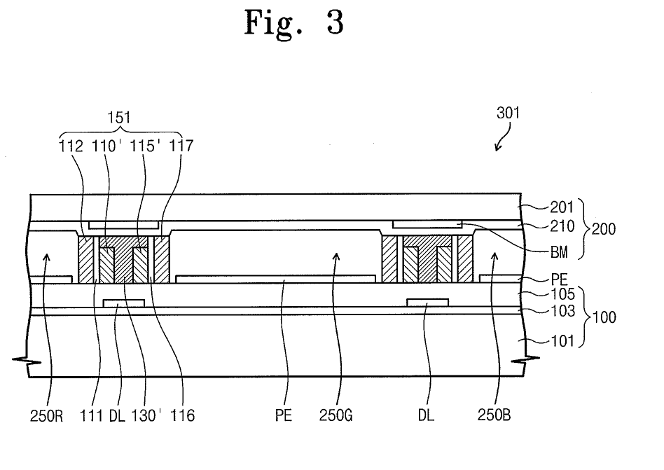

FIG. 3 is a cross-sectional view showing a display apparatus according to an exemplary embodiment of the present invention. In FIG. 3, the same reference numerals denote the same or similar elements in FIGS. 1, 2A, and 2B.

Referring to FIG. 3, a display apparatus 301 includes a first substrate 100 and a second substrate 200, and a barrier 151 arranged between the first substrate 100 and the second substrate 200. Similar to the barrier 150 (shown in FIG. 2A), the barrier 151 extends in a second direction D2 and is arranged between two adjacent pixel area groups, for example, first to third pixel area groups 260R, 260G, and 260B in a plan view.

The barrier 151 includes a first sub-barrier 110′, a second sub-barrier 115′, a third sub-barrier 112, and a fourth sub-barrier 117. The third sub-barrier 112 faces the second sub-barrier 115′, and the fourth sub-barrier 117 faces the first sub-barrier 110′.

Also, the third sub-barrier 112 is spaced apart from the first sub-barrier 110′ to form a first space 111 between the third sub-barrier 112 and the first sub-barrier 110′. In addition, the fourth sub-barrier 117 is spaced apart from the second sub-barrier 115′ to form a second space 116 between the second sub-barrier 115′ and the fourth sub-barrier 117.

Therefore, due to the presence of the first and second spaces 111 and 116, a coupling member 130′ arranged between and on the first sub-barrier 110′ and the second sub-barrier 115′ may be prevented from being flowed into the spaces in which first to third liquid crystal layers 250R, 250G, and 250B are filled. More particularly, the coupling member 130′ fills in the first space 111 and the second space 116 before the coupling member 130′ reaches the spaces in which the first to third liquid crystal layers 250R, 250G, and 250B are filled.

According to an exemplary embodiment shown in FIG. 3, since the barrier 151 further includes the third sub-barrier 112 and the fourth sub-barrier 117 in addition to the first and second sub-barriers 110′, 115′, the coupling member 130′ may be easily formed. In other words, the coupling member 130′ may be formed by curing a liquid type adhesive material, and therefore, due to the presence of the first and second spaces 111 and 116, and the third and fourth sub-barriers 112, 117, the margin of the amount of the adhesive material may be increased when the adhesive material is provided to the first sub-barrier 110′ and the second sub-barrier 115′ in order to form the coupling member 130′.

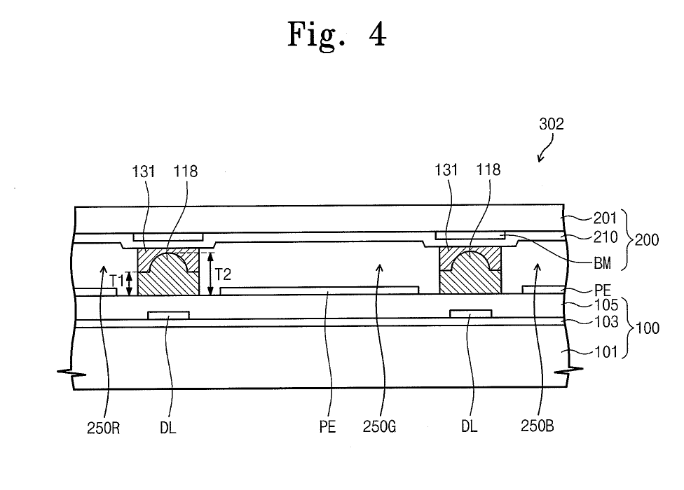

FIG. 4 is a cross-sectional view showing a display apparatus according to an exemplary embodiment of the present invention. In FIG. 4, the same reference numerals denote the same or similar elements in FIGS. 1, 2A, and 2B.

Referring to FIG. 4, a display apparatus 302 includes a first substrate 100 and a second substrate 200, and a barrier 118 is arranged between the first substrate 100 and the second substrate 200. Similar to the barrier 150 (shown in FIG. 2A), the barrier 118 extends in a second direction D2 and is arranged between two adjacent pixel area groups among first to third pixel area groups 260R, 260G, and 260B in a plan view.

However, unlike from the barrier 150 shown in FIG. 2B, the barrier 118 has a surface step difference in a cross-sectional view. That is, a portion of the barrier 118 has a first height T1, and a remaining part of the barrier 118 has a second height T2. According to an exemplary embodiment, a difference between the first height T1 and the second height T2 is equal to or less than about 0.5 micrometers.

As described above, when the barrier 118 has the surface step difference, a region in which the barrier 118 makes contact with the coupling member 131 increases, to thereby prevent the coupling member 131 from flowing into the spaces in which first to third liquid crystal layers 250R, 250G, and 250B are filled. In addition, in a case that the barrier 118 includes an organic layer and the coupling member 131 includes a material having a high affinity for the organic layer, such as NOA65 (Norland Optical Adhesive 65), it effectively prevents the coupling member 131 from flowing into the spaces in which the first to third liquid crystal layers 250R, 250G, and 250B are filled.

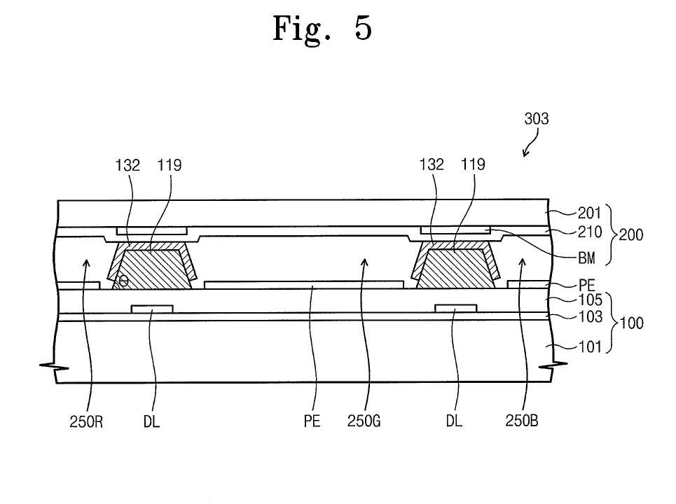

FIG. 5 is a cross-sectional view showing a display apparatus according to an exemplary embodiment of the present invention. In FIG. 5, the same reference numerals denote the same or similar elements in FIGS. 1, 2A, and 2B.

Referring to FIG. 5, a display apparatus 303 includes a first substrate 100 and a second substrate 200, and a barrier 119 is arranged between the first substrate 100 and the second substrate 200. Like the barrier 150 shown in FIG. 2A, the barrier 119 extends in a second direction D2 and is arranged between two adjacent pixel area groups among first to third pixel area groups 260R, 260G, and 260B in a plan view.

According to an exemplary embodiment, both side surfaces of the barrier 119 are inclined with respect to a first base substrate 101 of the first substrate 100 in a cross-sectional view. More specifically, each side surface of the barrier 119 forms an acute angle θ with the first base substrate 101. The acute angle θ may be in a range from about 30 degrees to less than about 90 degrees.

When the barrier 119 is inclined with respect to the first base substrate 101 in a cross-sectional view, an area where the barrier 119 and a coupling member 132 make contact with each other increases to prevent the coupling member 132 from flowing into a space where the first to third liquid crystal layers 250R, 250G, and 250B are filled.

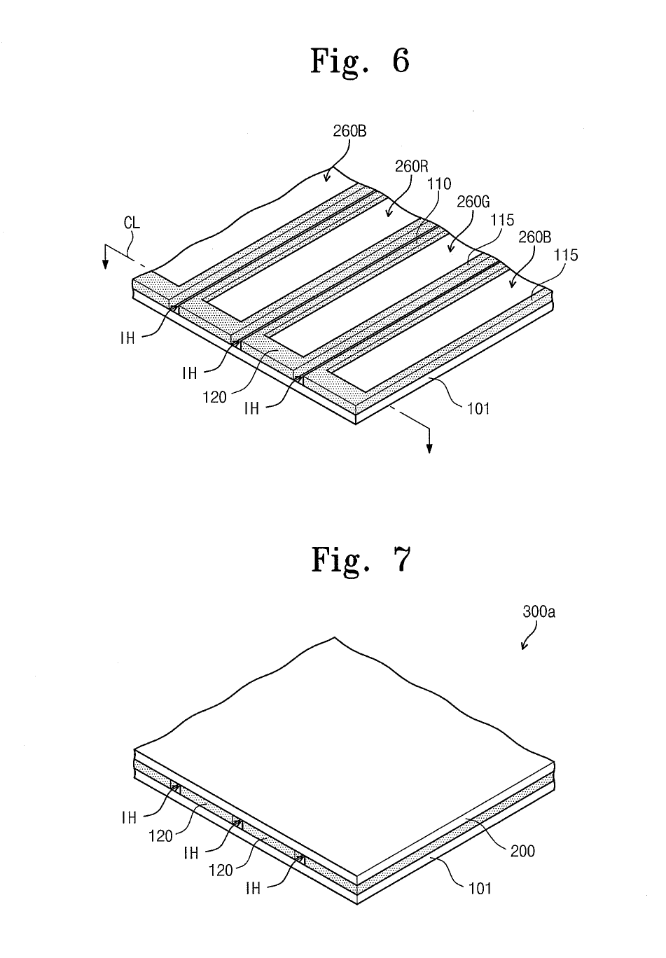

FIGS. 6 to 10 are views illustrating a method of manufacturing a display apparatus of FIG. 1. In FIGS. 6 to 10, the same reference numerals denote the same elements in FIGS. 1, 2A, and 2B.

Referring to FIG. 6, the gate line GL (shown in FIG. 2A), the data line DL (shown in FIG. 2A), the thin film transistor TR (shown in FIG. 2A), and the pixel electrode PE (shown in FIG. 2A) are formed on a first base substrate 101. Then, the first sub-barrier 110, the second sub-barrier 115, and a barrier connection part 120 are formed on the first base substrate 101.

The barrier connection part 120 is formed with the first and second sub-barriers 110 and 115. The barrier connection part 120 connects the first sub-barrier 110 with the second sub-barrier 115 to form spaces that are filled with first to third liquid crystal layers 250R, 250G, and 250B are filled, in first to third pixel area groups 260R, 260G, and 260B. The first sub-barrier 110 and the second sub-barrier 115 are spaced apart from each other and formed on the first base substrate 101. Injection holes IH are formed between the first and second sub-barriers 110, 115 that are spaced apart from each other.

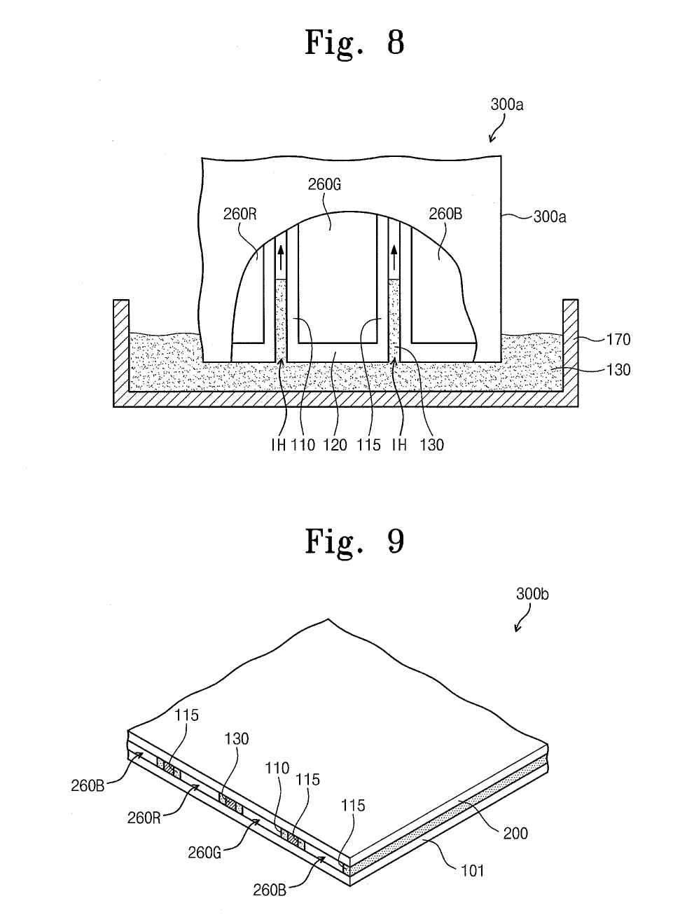

Referring to FIGS. 7 and 8, the first base substrate 101, on which the barrier connection part 120 and the first and second sub-barriers 110 and 115 (shown in FIG. 6) are formed, is coupled with the second substrate 200 to form a first preliminary display apparatus 300a. The first base substrate 101 may be coupled with the second substrate 200 using a coupling member, such as a sealant.

After forming the first preliminary display apparatus 300a, the coupling member 130 is injected between the first sub-barrier 110 and the second sub-barrier 115 through the injection holes IH. More particularly, when the coupling member 130 in liquid form fills a container 170 and the injection holes IH make contact with the coupling member 130 contained in the container 170, the coupling member 130 contained in the container 170 fills in the spaces between the first and second sub-barriers 110 and 115 through the injection holes IH due to a capillary phenomenon.

Also, as shown in FIG. 2B, in a case that a fine gap exists between the barriers 150 and the second substrate 200, the coupling member 130 simultaneously fills in the fine gap between the barriers 150 and the second substrate 200 while the coupling member 130 fills the spaces between the first and second sub-barriers 110 and 115 through the injection holes IH. As a result, the barriers 150 may be firmly coupled with the second substrate 200 by the coupling members 130.

Since the first to third pixel area groups 260R, 260G, and 260B are separated from the exterior by the barrier connection part 120, the coupling member 130 does not flow into the first to third pixel area groups 260R, 260G, and 260B. Then, the coupling member 130 filled between the first and second sub-barriers 110 and 115 through the injection holes IH is cured by heat or light.

Referring to FIG. 9, the second substrate 200 and the first base substrate 101 are cut to remove the barrier connection parts 120 (shown in FIG. 8) of the first preliminary display apparatus 300a (shown in FIG. 8) in which the coupling members 130 are formed in the injection holes IH (shown in FIG. 8), so that a second preliminary display apparatus 300b is formed. More particularly, the second substrate 200 and the first base substrate 101 are cut along a cutting line CL shown in FIG. 6. Accordingly, regions between the first base substrate 101 and the second substrate 200 are exposed to the exterior corresponding to the first to third pixel area groups 260R, 260G, and 260B.

After forming the second preliminary display apparatus 300b, a first liquid crystal is injected between the first base substrate 101 and the second substrate 200 corresponding to the first pixel area group 260R to form the first liquid crystal layer 250R (shown in FIG. 2B), a second liquid crystal is injected between the first base substrate 101 and the second substrate 200 corresponding to the second pixel area group 260G to form the second liquid crystal layer 250G (shown in FIG. 2B), and a third liquid crystal is injected between the first base substrate 101 and the second substrate 200 corresponding to the third pixel area group 260B to form the third liquid crystal layer 250B (shown in FIG. 2B).

As described above with reference to FIGS. 1, 2A, and 2B, the first to third liquid crystal layers 250R, 250G, and 250B may include the cholesteric liquid crystal, and the first to third liquid crystal layers 250R, 250G, and 250B may include the different amounts of chiral dopant from each other.

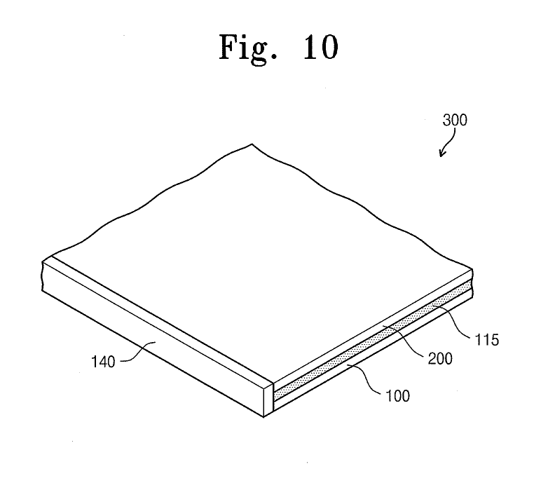

Referring to FIG. 10, after forming the first to third liquid crystal layers 250R, 250G, and 250B, inlets through which the first to third liquid crystals are injected are sealed using a sealant to seal the first to third liquid crystal layers 250R, 250G, and 250B, to thereby complete the display apparatus 300.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a first base substrate including pixel areas;
a second base substrate facing the first base substrate;
pixel electrodes arranged on the first base substrate respectively corresponding to the pixel areas;
a common electrode arranged on the second base substrate;
barriers each having at least two sub-barriers spaced apart from each other, the barriers being arranged on the first base substrate or on the second base substrate;
a coupling member arranged between and on each of the at least two sub-barriers to couple the first base substrate with the second base substrate; and
a liquid crystal layer disposed between the first base substrate and the second base substrate.

2. The display apparatus of claim 1, further comprising:
gate lines arranged on the first base substrate;
data lines arranged on the first base substrate and insulated from the gate lines; and
thin film transistors arranged on the first base substrate and each thin film transistor being respectively electrically connected to the gate lines, the data lines, and the pixel electrodes,
wherein the barriers and the coupling members extend along the gate lines or the data lines in a plan view.

3. The display apparatus of claim 1, wherein the pixel areas are divided into a plurality of pixel area groups by the barriers.

4. The display apparatus of claim 3, wherein the pixel area groups comprise:
a first pixel area group;
a second pixel area group; and
a third pixel area group, and
wherein each of the first, second and third pixel area groups are positioned between two adjacent barriers.

5. The display apparatus of claim 4, wherein each of the barriers comprises:
a first sub-barrier; and
a second sub-barrier that is spaced apart from the first sub-barrier, wherein the coupling member is disposed between the first and second sub-barriers.

6. The display apparatus of claim 5, wherein each of the barriers further comprises:
a third sub-barrier spaced apart from the first sub-barrier and facing an outside wall of the first sub-barrier; and
a fourth sub-barrier spaced apart from the second sub-barrier and facing an outside wall of the second sub-barrier.

7. The display apparatus of claim 4, wherein the liquid crystal layer comprises:
a first liquid crystal layer arranged between the first base substrate and the second base substrate corresponding to the first pixel area group;
a second liquid crystal layer arranged between the first base substrate and the second base substrate corresponding to the second pixel area group; and
a third liquid crystal layer arranged between the first base substrate and the second base substrate corresponding to the third pixel area group.

8. The display apparatus of claim 7, wherein each of the first, second, and third liquid crystal layers comprises a cholesteric liquid crystal, and at least one liquid crystal layer of the first, second, and third liquid crystal layers is doped with a different amount of dopant from the remaining two liquid crystal layers.

9. A display apparatus comprising:
a first base substrate including pixel areas;
a second base substrate facing the first base substrate;
pixel electrodes arranged on the first base substrate respectively corresponding to the pixel areas;
a common electrode arranged on the second base substrate;
barriers arranged on the first base substrate or on the second base substrate;
a coupling member arranged on each of the barriers to couple the first base substrate with the second base substrate; and
a liquid crystal layer filling spaces that are defined by the barriers and the coupling members between the first base substrate and the second base substrate, wherein each of the barriers includes a rounded shape that makes contact with the coupling member.

10. A display apparatus comprising:
a first base substrate including pixel areas;
a second base substrate facing the first base substrate;
pixel electrodes arranged on the first base substrate respectively corresponding to the pixel areas;
a common electrode arranged on the second base substrate;
barriers arranged on the first base substrate or on the second base substrate;
a coupling member arranged on each of the barriers to couple the first base substrate with the second base substrate; and
a liquid crystal layer filling spaces that are defined by the barriers and the coupling members between the first base substrate and the second base substrate, and
wherein each of the barriers has at least one side surface that is inclined with respect to the first and second base substrates, and the coupling member extends from an upper portion of each of the barriers to the side surface of each of the barriers.

11. A method of manufacturing a display apparatus, comprising:
forming pixel electrodes on a first base substrate having pixel areas to respectively correspond to each pixel area;
forming a common electrode on a second base substrate;
forming barriers, each having at least two sub-barriers spaced apart from each other, on the first base substrate or the second base substrate, wherein the barriers divide the pixel areas into a plurality of pixel area groups;
coupling the first base substrate with the second base substrate, wherein the barriers are positioned between the first base substrate and the second base substrate;
forming a coupling member between and on each of the at least two sub-barriers to couple the barriers with the first and second base substrates; and
forming a liquid crystal layer between the first base substrate and the second base substrate.

12. The method of claim 11, further comprising:
forming gate lines on the first base substrate;
forming data lines insulated from the gate lines on the first base substrate; and
forming thin film transistors that are respectively electrically connected to the gate lines, the data lines, and the pixel electrodes on the first base substrate,
wherein the barriers and the coupling members extend along the gate lines and the data lines in a plan view.

13. The method of claim 11, wherein the pixel areas are divided into a first pixel area group, a second pixel area group, and a third pixel area group by the barriers.

14. The method of claim 13, wherein the forming the barriers comprises:
forming a first sub-barrier; and
forming a second sub-barrier that is spaced apart from the first sub-barrier.

15. The method of claim 14, further comprising forming a barrier connection part that connects a first sub-barrier of a first barrier with a second sub-barrier of a second barrier adjacent the first barrier, wherein one pixel area group of the first, second, and third pixel area groups is interposed between the two adjacent barriers.

16. The method of claim 15, wherein an injection hole is formed between a first sub-barrier and a second sub-barrier of the same barrier by two barrier connection parts.

17. The method of claim 16, wherein the coupling member is injected into the injection hole.

18. The method of claim 15, after coupling the first base substrate with the second base substrate, further comprising:
cutting the coupled first and second base substrates to remove the barrier connection part to expose an area between the first and second base substrates to an exterior, the area corresponding to the first, second and third pixel area groups; and
forming a first liquid crystal injection hole corresponding to the first pixel area group, a second liquid crystal injection hole corresponding to the second pixel area group, and a third liquid crystal injection hole corresponding to the third pixel area group.

19. The method of claim 18, wherein forming the liquid crystal layer comprises:
injecting a first liquid crystal through the first liquid crystal injection hole;
injecting a second liquid crystal through the second liquid crystal injection hole; and
injecting a third liquid crystal through the third liquid crystal injection hole,
wherein each of the first, second, and third liquid crystal comprises a cholesteric liquid crystal, and at least one liquid crystal of the first, second, and third liquid crystals comprises a different amount of dopant from the remaining liquid crystals.

20. The method of claim 15, further comprising curing the coupling member.
